(19) United States
(12) Patent Application Publication
(10) Pub. No.: US 2016/0052769 A1
(43) Pub. Date: Feb. 25, 2016

(54) WATER DISPENSER

(71) Applicant: KABUSHIKI KAISHA COSMO LIFE, Hyogo (JP)

(72) Inventor: Yoshinori ORITA, Hyogo (JP)

(21) Appl. No.: 14/780,058

(22) PCT Filed: Dec. 18, 2013
(86) PCT No.: PCT/JP2013/083861

§ 371 Date: Sep. 25, 2015

(30) Foreign Application Priority Data
Mar. 26, 2013 (JP) 2013-063594

(51) Int. Cl. B67D 1/00; B67D 1/08; B67D 1/10

(52) U.S. Cl. CPC B67D 1/0009; B67D 1/0014; B67D 1/10; B67D 1/0895; B67D 1/0857

(57) ABSTRACT

The following water dispenser is provided. A circulation path is constituted by a water receiving container configured to receive drinking water flowing from the raw water container, a raw water supply line through which drinking water received in the water receiving container is supplied to a cold water tank by a pump, and first and second return pipes through which drinking water flowing in the raw water supply line returns to the water receiving container. The first return pipe is connected to the second return pipe through a hot water tank, and heated water is supplied to the circulation path from the hot water tank so as to sterilize the water receiving container, etc. at a high temperature.

### TECHNICAL FIELD

The present invention relates to a water dispenser in which drinking water is supplied from a replaceable raw water container filled with drinking water.

### BACKGROUND ART

As disclosed in the below-identified patent document 1, etc., a water dispenser is known in which a replaceable raw water container filled with drinking water such as mineral water is placed on the top portion of the water dispenser, and drinking water supplied from the raw water container is cooled by a cooling device or heated by a heating device, and then supplied to a user. Since interest in the safety of water or in health is growing, such water dispensers are being used in many places such as hospitals and ordinary homes.

In the water dispenser disclosed in patent document 1, a raw water container is placed on the top portion of the water dispenser. In this arrangement, when the raw water container placed on the water dispenser empties, it is necessary to lift a new raw water container filled with drinking water (about 8-12 kg) to a high position for container replacement, and such replacement work is a big burden on people whose strength is weak, such as elderly people and women. In order to easily conduct the work of container replacement, the inventor experimentally produced a water dispenser in which a raw water container is placed in the lower portion of the water dispenser with the raw water container directed downwardly, and drinking water is supplied from the raw water container by a pump.

The structure of the water dispenser is now described with reference to FIG. 5. This water dispenser includes a casing 1, a cold water tank 2 which is mounted in the casing 1 and in which drinking water is cooled, a container holder 5 which is arranged at a lower level than the cold water tank 2, and on which a replaceable raw water container 3 is to be placed with a water outlet 4 of the raw water container 3 directed downwardly, an insertion pipe 6 attached to the container holder 5, and configured to be inserted into the water outlet 4 of the raw water container 3 when the raw water container 3 is placed on the container holder 5, and a water receiving container 7 configured to receive drinking water flowing out of the water outlet 4 of the raw water container 3 through the insertion pipe 6. The water receiving container 7 is formed with an air hole 8 through which air is introduced into the water receiving container 7 and discharged from the water receiving container 7.

The bottom end of the insertion pipe 6 is located inside of the water receiving container 7. The water receiving container 7 has a raw water supply line 10 connected thereto through which drinking water received in the water receiving container 7 is supplied to the cold water tank 2 by a pump 9.

The cold water tank 2 is provided in its interior with a baffle plate 12. Drinking water stored under the baffle plate 12 is cooled by a cooling device 13 attached to the lower portion of the cold water tank 2. The cold water tank 2 has a tank connection line 15 connected thereto through which drinking water is sent out of the cold water tank 2 to a hot water tank 14 provided at under the cold water tank 2. The hot water tank 14 is provided with a heating device 16 configured to heat drinking water in the hot water tank 14. Furthermore, the hot water tank 14 has a drain pipe 17 connected to its lower portion and communicating with the exterior of the water dispenser. A cap 18 is detachably attached to the end of the drain pipe 17 so as to prevent water from flowing out of the drain pipe 17. When the maintenance of the water dispenser is performed, it is possible to discharge drinking water remaining in the cold water tank 2 or in the hot water tank 14 to the outside of the water dispenser through the drain pipe 17.

A cold water discharge line 19 is connected to the cold water tank 2, and cold water is discharged from a cold water cock 21 mounted to the cold water discharge line 19. A hot water discharge line 20 is connected to the hot water tank 14, and hot water is discharged from a hot water cock 22 mounted to the hot water discharge line 20. The cold water tank 2 is provided in its interior with a water level sensor 23 which detects the water level of drinking water stored in the cold water tank 2. When the water level detected by the water level sensor 23 has fallen below a predetermined level, an electric motor 24 is turned on so as to activate the pump 9, so that drinking water in the water receiving container 7 is supplied to the cold water tank 2 through the raw water supply line 10. When, as a result, the water level in the water receiving container 7 falls below the bottom end of the insertion pipe 6, air flows into the raw water container 3 through the air hole 8 and the insertion pipe 6, and drinking water in the raw water container 3 flows into the water receiving container 7 through the insertion pipe 6.

Though the raw water container 3 used in such a water dispenser can be broadly divided into a hard container whose volume does not change when drinking water is discharged from the container, and a soft container whose volume decreases when drinking water is discharged from the container, a hard container is used in the water dispense having the above structure due to the following reason: Since the volume of a hard container does not decrease when drinking water is discharged from the hard container, it is easy to keep balance among atmospheric pressure, water's gravity, and the pressure of air in the hard container, and when the water level in the water receiving container 7 reaches the bottom end of the insertion pipe 6, it is possible to promptly stop supplying drinking water from the raw water container 3 to the water receiving container 7.

### PRIOR ART DOCUMENT(S)

### Patent Document(s)

Patent document 1: Japanese Unexamined Patent Application Publication No. 2010-264993

### SUMMARY OF THE INVENTION

### Problems to be Solved by the Invention

In the water dispenser having the structure illustrated in FIG. 5, room-temperature drinking water which has not been cooled in the cold water tank 2 yet flows in the water receiving container 7, the raw water supply line 10, and the pump 9. If this water dispenser is not used for a long time, since this room-temperature drinking water remains therein, germs may proliferate in the raw water receiving container 7, etc.

It is an object of the present invention to prevent germs from proliferating in the flow path of drinking water so as to keep drinking water very hygienic.

### Means for Solving the Problems

In order to achieve the above object, the present invention provides a water dispenser comprising: a cold water tank in which drinking water is to be cooled; a hot water tank in which drinking water is to be heated; a container holder which is arranged at a lower level than the cold water tank, and on which a replaceable raw water container is to be placed with a water outlet of the raw water container directed downwardly; an insertion pipe attached to the container holder, and configured to be inserted into the water outlet of the raw water container when the raw water container is placed on the container holder; a water receiving container configured to receive drinking water flowing into the water receiving container from the water outlet of the raw water container through the insertion pipe; a raw water supply line configured such that drinking water received in the water receiving container can be supplied to the cold water tank through the raw water supply line by a pump; a return pipe branching off from an end portion of the raw water supply line on a side of the cold water tank, and connected to the water receiving container; a switch valve provided at a branch point where the return pipe branches off from the raw water supply line (10), and configured to move between a normal state position in which the switch valve blocks communication between the raw water supply line and the return pipe and a circulation state position in which the switch valve allows communication between the raw water supply line and the return pipe, while blocking communication between the raw water supply line and the cold water tank; and a heating means for heating drinking water flowing through a circulation path constituted by the water receiving container, the raw water supply line, the switch valve, and the return pipe.

In this arrangement, by circulating heated drinking water through the circulation path, it is possible to sterilize (disinfect) at a high temperature the interiors of the water receiving container, the raw water supply line, and the pump in which room-temperature drinking water can remain. Therefore, it is possible to prevent the proliferation of germs, and thus to keep drinking water very hygienic.

In the above arrangement, the hot water tank may be disposed at an intermediate portion of the return pipe, and the heating means may comprise the hot water tank.

The hot water tank is provided with a heating device for heating drinking water in the hot water tank. If the hot water tank is disposed at an intermediate portion of the return pipe, and drinking water flowing in the circulation path is heated by the heating device, it is not necessary to separately provide a heating device. Therefore, it is possible to simplify the structure of the water dispenser.

In the above arrangement in which the hot water tank is disposed at an intermediate portion of the return pipe, the water dispenser may be configured such that the hot water tank is provided with a drain pipe configured such that drinking water remaining in the hot water tank can be discharged through the drain pipe, and a hot water discharge line configured such that drinking water in the hot water tank can be sent out through the hot water discharge line, wherein the return pipe is constituted by a first return pipe configured such that drinking water can flow from the switch valve to the hot water tank through the first return pipe, and a second return pipe configured such that drinking water can flow from the hot water tank to the water receiving container through the second return pipe, and wherein the first return pipe is connected to the drain pipe, and the second return pipe is connected to the hot water discharge line.

The hot water tank has a plurality of pipes/lines connected thereto, such as the drain pipe and the hot water discharge line. When the hot water tank per se expands and shrinks due to the temperature change which occurs by turning on and turning off the heating device mounted to the hot water tank, the portions of the hot water tank to which the respective pipes/lines are connected gradually fatigue, which could lead to the formation of small cracks through which water leaks. The larger the number of pipes/lines connected to the hot water tank is, the more outstanding this problem tends to be.

It is possible to reduce the number of pipes/lines directly connected to the hot water tank by connecting the first return pipe to the drain pipe and connecting the second return pipe to the hot water discharge line as described above, and thus to prevent water from leaking through the portions of the hot water tank to which the respective pipes/lines are connected.

Instead of disposing the hot water tank at an intermediate portion of the return pipe as described above, the heating means may comprise a heating device attached to the circulation path.

When drinking water in the hot water tank flows into the circulation path as described above, right after the pump is activated for the sterilization work, though drinking water in the water receiving container is sucked into the raw water supply line due to negative pressure by the pump, air is sucked into the water receiving container through the air vent hole, so that the negative pressure may not be transmitted to the return pipes, and thus drinking water in the return pipes may not flow. Under this situation, though drinking water flows into the hot water tank, hot water does not flow out of the hot water tank. As a result thereof, the amount of water increases in the hot water tank, so that water may flow from the hot water tank to the cold water tank. In order to prevent water from flowing from the hot water tank to the cold water tank, a check valve, etc. is attached to a tank connection line in some cases.

On the other hand, in the arrangement in which, during the sterilization work, hot water in the hot water tank is not used, and drinking water in the circulation path is heated by the heating device directly attached to the circulation path, drinking water never flows from the hot water tank to the cold water tank so that the check valve, etc. is not necessary. Therefore, it is possible to simplify the structure of the water dispenser.

In the arrangement in which the heating device is directly attached to the circulation path, it is preferable that the heating device is attached to the raw water supply line.

Though the return pipe is filled with drinking water only when the sterilization work is conducted, the raw water supply line is always filled with drinking water as long as the raw water container (water receiving container) does not empty. Therefore, the risk is low that when the heating device is energized due to the start of the sterilization work, the heating device heats the raw water supply line where there is no water, thus making it possible to secure high safety.

### Effects of the Invention

In the present invention, the circulation path is constituted by the water receiving container, the raw water supply line, the switch valve, and the return pipe, and heated water circulates through the circulation path. By circulating heated water in this way so as to sterilize (disinfect) the water receiving container, etc. at a high temperature, it is possible to prevent the generation of germs in the interiors of the water receiving container, the raw water supply line, and the pump in which room-temperature drinking water can remain, and thus to keep drinking water very hygienic.

### BRIEF DESCRIPTION OF THE DRAWINGS

FIG. 1 is a longitudinal sectional view of a water dispenser according to a first embodiment of the present invention, the sectional view illustrating the state (normal state) in which water flows from a raw water supply line to a cold water tank.

FIG. 2 is a longitudinal sectional view of the water dispenser according to the first embodiment of the present invention, the sectional view illustrating the state (circulation state) in which water flows from the raw water supply line to return pipes.

FIG. 3 is a longitudinal sectional view of a water dispenser according to a second embodiment of the present invention.

FIG. 4 is a longitudinal sectional view of a water dispenser according to a third embodiment of the present invention.

FIG. 5 is a longitudinal sectional view of a water dispenser according to a comparative example.

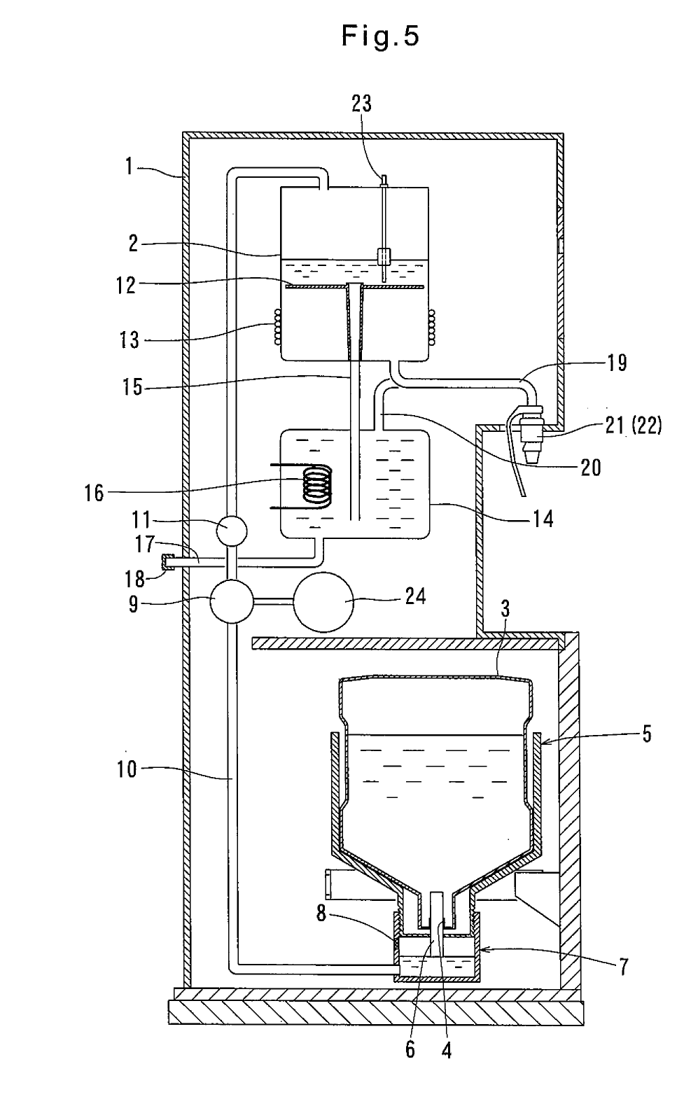

### BEST MODE FOR CARRYING OUT THE INVENTION

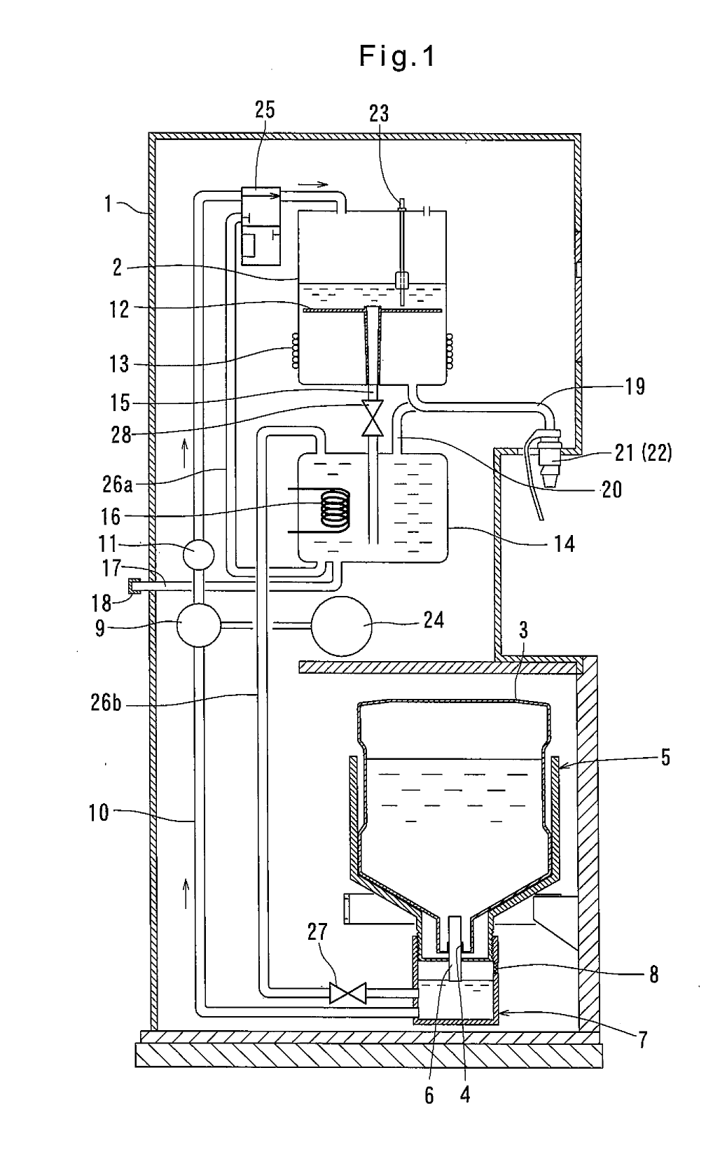

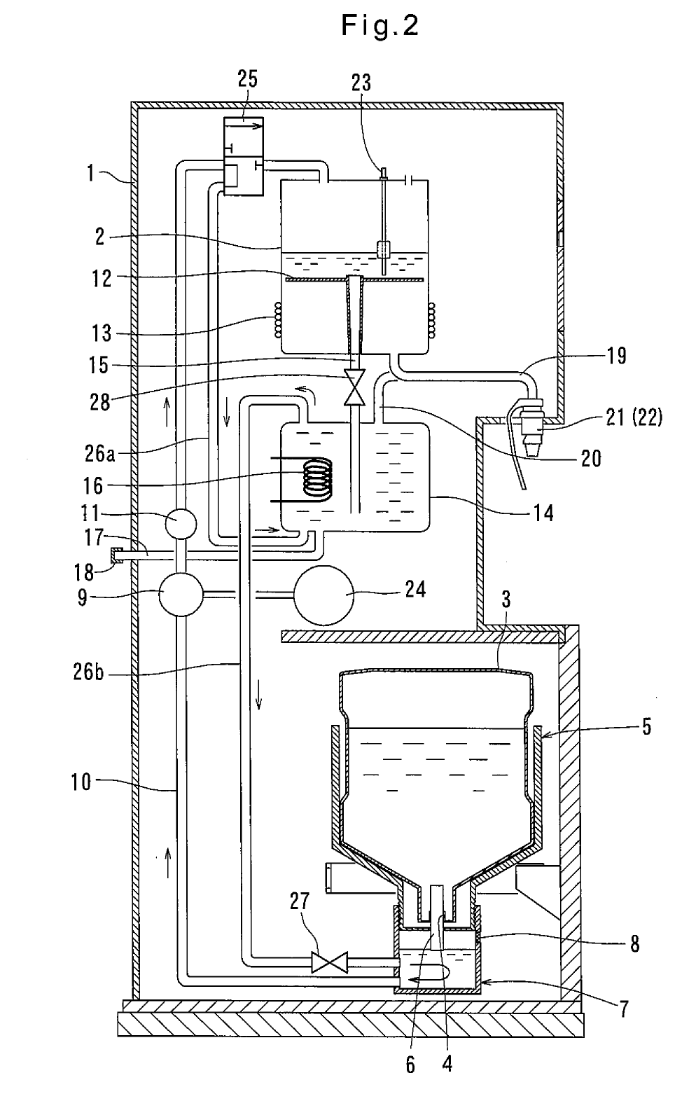

FIGS. 1 and 2 illustrate a water dispenser according to the first embodiment of the present invention. This water dispenser includes a casing 1, a cold water tank 2 which is mounted in the casing 1 and in which drinking water is cooled, a container holder 5 which is arranged at a lower level than the cold water tank 2, and on which a replaceable raw water container 3 is to be placed with a water outlet 4 of the raw water container 3 directed downwardly, an insertion pipe 6 attached to the container holder 5, and configured to be inserted into the water outlet 4 of the raw water container 3 when the raw water container 3 is placed on the container holder 5, and a water receiving container 7 configured to receive drinking water flowing out of the water outlet 4 of the raw water container 3 through the insertion pipe 6. The water receiving container 7 is formed with an air hole 8 through which air is introduced into the water receiving container 7 and discharged from the water receiving container 7.

The bottom end of the insertion pipe 6 is located inside of the water receiving container 7. The water receiving container 7 has a raw water supply line 10 connected thereto through which drinking water received in the water receiving container 7 is supplied to the cold water tank 2 by a pump 9. A flow sensor 11 is attached to the raw water supply line 10. If drinking water in the raw water supply line 10 disappears while the pump 9 is operating, the flow sensor 11 detects this state.

The cold water tank 2 is provided in its interior with a baffle plate 12. Drinking water stored under the baffle plate 12 is cooled by a cooling device 13 attached to the lower portion of the cold water tank 2. The baffle plate 12 prevents drinking water cooled by the cooling device 13 from mixing directly with room-temperature drinking water supplied to the cold water tank 2 through the raw water supply line 10. The cold water tank 2 has a tank connection line 15 connected thereto through which drinking water is sent out of the cold water tank 2 to a hot water tank 14 provided under the cold water tank 2. The hot water tank 14 is provided with a heating device 16 configured to heat drinking water in the hot water tank 14. Furthermore, the hot water tank 14 has a drain pipe 17 connected to its bottom portion and communicating with the exterior of the water dispenser. A cap 18 is detachably attached to the end of the drain pipe 17 so as to prevent water from flowing out of the drain pipe 17. When the maintenance of the water dispenser is performed, it is possible to discharge drinking water remaining in the cold water tank 2 and/or in the hot water tank 14 to the outside of the water dispenser through the drain pipe 17.

A cold water discharge line 19 is connected to the cold water tank 2, and cold water is discharged from a cold water cock 21 mounted to the cold water discharge line 19. A hot water discharge line 20 is connected to the hot water tank 14, and hot water is discharged from a hot water cock 22 mounted to the hot water discharge line 20. The cold water tank 2 is provided in its interior with a water level sensor 23 which detects the water level of drinking water stored in the cold water tank 2. When the water level detected by the water level sensor 23 has fallen below a predetermined level, an electric motor 24 is turned on so as to activate the pump 9, so that drinking water in the water receiving container 7 is supplied to the cold water tank 2 through the raw water supply line 10. When, as a result, the water level in the water receiving container 7 falls below the bottom end of the insertion pipe 6, air flows into the raw water container 3 through the air hole 8 and the insertion pipe 6, and drinking water in the raw water container 3 flows into the water receiving container 7 through the insertion pipe 6. The raw water container 3 is a hard container whose volume does not change when drinking water is discharged from the container.

A switch valve 25 is provided at the end portion of the raw water supply line 10 on the side of the cold water tank 2. The switch valve 25 is connected to the hot water tank 14 through a first return pipe 26a. The water receiving container 7 is connected to the hot water tank 14 through a second return pipe 26b. Namely, a circulation path is constituted by the water receiving container 7, the raw water supply line 10, the switch valve 25, and the first and second return pipes 26a, 26b, with the hot water tank 14 disposed in the circulation path. The switch valve 25 can switch the flow of drinking water by moving between a normal state position in which the switch valve 25 blocks communication between the raw water supply line 10 and the first return pipe 26a, and a circulation state position in which the switch valve 25 allows communication between the raw water supply line 10 and the first return pipe 26a, while blocking communication between the raw water supply line 10 and the cold water tank 2. An on-off valve 27 is provided at the end portion of the second return pipe 26b connecting to the water receiving container 7. The on-off valve 27 controls the flow of heated water between the second return pipe 26b and the water receiving container 7.

When the water dispenser is used in the normal mode, the switch valve 25 is in the above normal state position as illustrated in FIG. 1, so that when the water level in the cold water tank 2 falls, drinking water is supplied to the cold water tank 2 through the raw water supply pipe 10 (see the arrows illustrated in FIG. 1).

On the other hand, when the water receiving container 7, the raw water supply line 10 and the pump 9 are sterilized, the switch valve 25 is in the above circulation state position as illustrated in FIG. 2, and the on-off valve 27 is kept open. As a result thereof, water heated in the hot water tank 14 circulates through the interiors of the water receiving container 7, the raw water supply line 10 and the pump 9 (see the arrows illustrated in FIG. 2), so that the water receiving container 7, etc. are sterilized. During sterilization, drinking water is preferably heated by energizing the heating device 16, mounted to the hot water tank 14, so that the temperature of the heated water does not fall during this sterilization work.

Furthermore, the tank connection line 15 is preferably provided with a check valve 28 for preventing hot water in the hot water tank 14 from flowing back into the cold water tank 2 when the amount of water temporarily increases in the hot water tank 14 right after activating the pump 9 for sterilization.

After circulating heated water through the circulation path for a predetermined period of time, the sterilization work by heated water is completed by moving the switch valve 25 again to the normal state position, and closing the on-off valve 27. By regularly conducting this sterilization work, it is possible to prevent the generation of germs in the raw water supply line 10, etc., and thus to keep the water dispenser very hygienic.

Since drinking water in the hot water tank 14 is heated by the heating device 16, mounted to the hot water tank 14, and since the higher the water temperature, the lower its specific gravity, the higher the water is located in the hot water tank 14, the higher its temperature, and the lower the water is located in the hot water tank 14, the lower its temperature. Therefore, by connecting the first and second return pipes 26a, 26b to the hot water tank 14 as illustrated in FIG. 2, heated water for sterilization is supplied to the circulation path from the top portion of the hot water tank 14, in which hotter water is stored, so that it is possible to efficiently conduct the sterilization work.

In this arrangement, in order to prevent water heated in the hot water tank 14 from cooling down while circulating through the circulation path, and thus to maintain the sterilization effect, it is preferable that the capacity of the water receiving container 7 is made as small as possible while not impairing the function of the water receiving container 7. For example, if the hot water tank 14 has a capacity of 1.5 liters, by using the water receiving container 7 having a capacity of about 0.3 liters or less, it is possible to keep the temperature of heated water as high as possible.

In the above arrangement, in which the first and second return pipes 26a, 26b are connected to each other through the hot water tank 14 so that drinking water circulating through the circulation path is heated by the heating device 16, it is not necessary to separately provide a heating device. Therefore, it is possible to simplify the structure of the water dispenser.

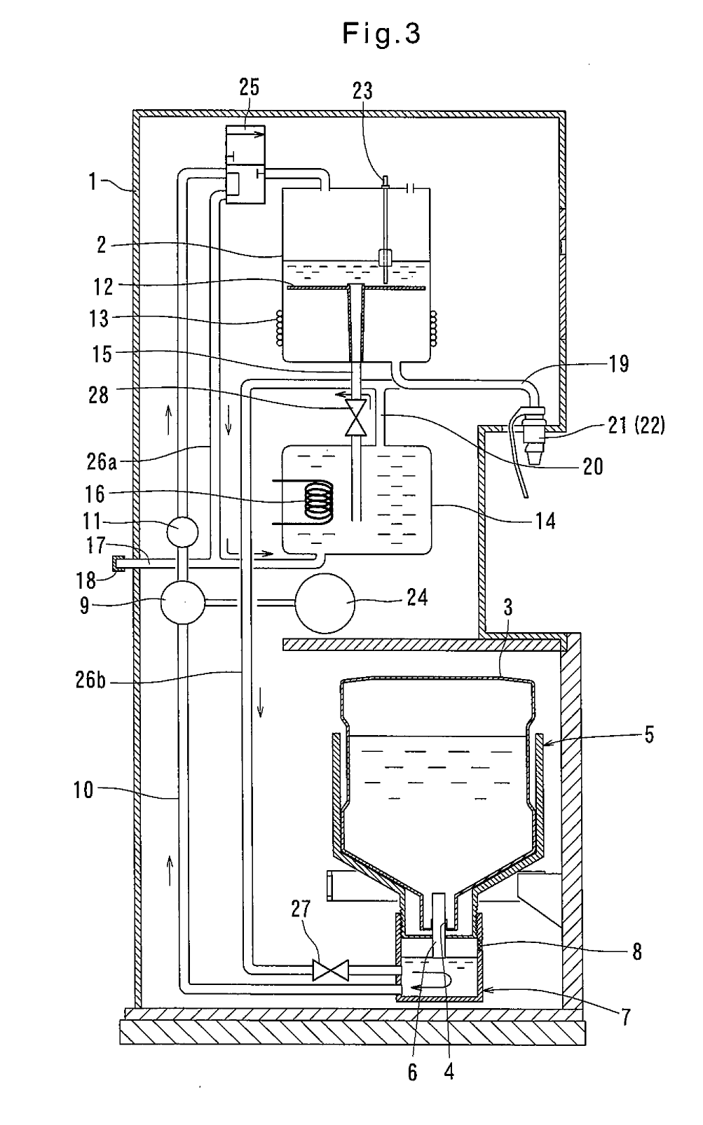

FIG. 3 illustrates a water dispenser according to the second embodiment of the present invention. This water dispenser is the same as that of the first embodiment in that the hot water tank 14 is disposed in an intermediate portion of the flow path leading to the second return pipe 26b from the first return pipe 26a. However, the first and second return pipes 26a, 26b in the second embodiment are different in arrangement from those in the first embodiment. Namely, the first and second return pipes 26a and 26b of the second embodiment are not directly connected to the hot water tank 14, but are connected, respectively, to the drain pipe 17 and the hot water discharge line 20, which are both connected to the hot water tank 14.

When the hot water tank 14 per se expands and shrinks due to the temperature change which occurs by turning on and turning off the heating device 16 mounted to the hot water tank 14, the portions of the tank 14 to which the respective pipes/lines are connected gradually fatigue, which could lead to the formation of small cracks through which water leaks. The larger the number of pipes/lines connected to the hot water tank 14 is, the more outstanding this problem tends to be. In this regard, while five pipes/lines, namely, the tank connection line 15, the drain pipe 17, the hot water discharge line 20, the first return pipe 26a, and the second return pipe 26b are connected to the hot water tank 14 in the water dispenser according to the first embodiment, only three pipes/lines, namely, the tank connection line 15, the drain pipe 17, and the hot water discharge line 20 are directly connected to the hot water tank 14 in the water dispenser according to the second embodiment. By reducing the number of pipes/lines connected to the hot water tank 14 in this way, it is possible to prevent the above water leakage.

Though the first return pipe 26a is connected to the drain pipe 17, and the second return pipe 26b is connected to the hot water discharge line 20 in the water dispenser of the second embodiment, one of the return pipes 26a and 26b may be directly connected to the hot water tank 14 This is because even in this arrangement, the number of pipes/lines connected to the hot water tank 14 is smaller than the number of such pipes/lines in the water dispenser of the first embodiment, thereby contributing to the prevention of the above water leakage.

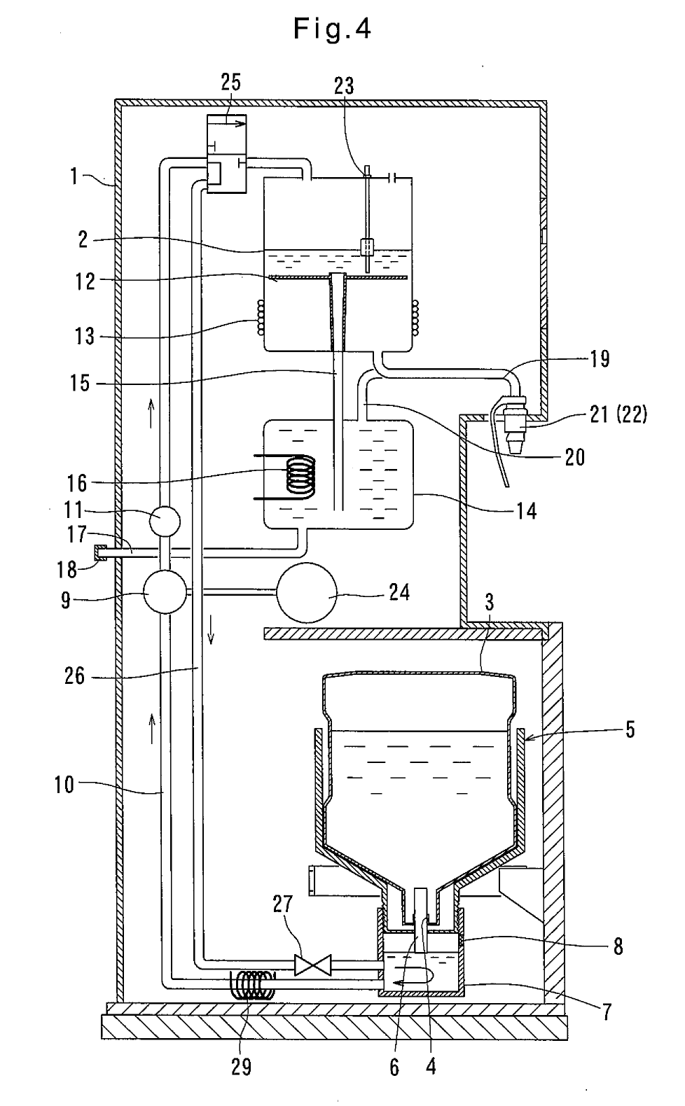

FIG. 4 illustrates a water dispenser according to the third embodiment of the present invention. This water dispenser is the same in fundamental structure as those of the first and second embodiments, but different from those of the first and second embodiments in that the hot water tank 14 is not disposed in the circulation path. Namely, in the water dispenser of the third embodiment, the switch valve 25 is directly connected to the water receiving container 7 through a return pipe 26, thereby constituting the circulation path. In this arrangement, since it is not possible to supply heated water to the circulation path from the hot water tank 14, for example, as illustrated in FIG. 4, a heating device 29 is attached to the raw water supply line 10, and by energizing the heating device 29, drinking water flowing in the raw water supply line 10 is directly heated by the heating device 29 so that heated water is produced.

In the arrangement according to the third embodiment, since the return pipe 26 is not directly connected to the hot water tank 14, when the pump 9 is activated for the sterilization work, hot water in the hot water tank 14 never flows into the cold water tank 2. Therefore, it is possible to omit the check valve 28 used in each of the first and second embodiments.

The heating device 29 may be attached to any portion of the circulation path. However, as illustrated in FIG. 4, it is preferable that the heating device 29 is attached to the raw water supply line 10, especially to the portion of the raw water supply line 10 lower than the water surface in the water receiving container 7. This portion of the raw water supply line 10, i.e. its portion lower than the water surface in the water receiving container 7 is always filled with drinking water, as long as the raw water container 3 (water receiving container 7) does not empty. Therefore, compared to the arrangement in which the heating device 29 is attached to the return pipe 26 where there is frequently no water when the sterilization work is not conducted, the risk is low that when the heating device 29 is energized due to the start of the sterilization work, the heating device 29 heats the raw water supply line 10 where there is no water, thus making it possible to secure high safety.

The above arrangements according to the first, second and third embodiments are described as examples, and may be modified as necessary, provided that the object of the present invention can be achieved.

### DESCRIPTION OF REFERENCE NUMERALS

1: casing
2: cold water tank
3: raw water container
4: water outlet
5: container holder
6: insertion pipe
7: water receiving container
8: air hole
9: pump
10: raw water supply line
11: flow sensor
12: baffle plate
13: cooling device
14: hot water tank
15: tank connection line
16: heating device (attached to hot water tank)
17: drain pipe
18: cap
19: cold water discharge line
20: hot water discharge line
21: cold water cock
22: hot water cock
23: water level sensor
24: electric motor
25: switch valve
26: return pipe
26a: first return pipe
26b: second return pipe
27: on-off valve
28: check valve
29: heating device (attached to circulation path)

1. A water dispenser comprising:
a cold water tank in which drinking water is to be cooled;
a hot water tank in which drinking water is to be heated;
a container holder which is arranged at a lower level than the cold water tank, and on which a replaceable raw water container is to be placed with a water outlet of the raw water container directed downwardly;
an insertion pipe attached to the container holder, and configured to be inserted into the water outlet of the raw water container when the raw water container is placed on the container holder;
a water receiving container configured to receive drinking water flowing into the water receiving container from the water outlet of the raw water container through the insertion pipe;
a raw water supply line configured such that drinking water received in the water receiving container can be supplied to the cold water tank through the raw water supply line by a pump;
a return pipe branching off from an end portion of the raw water supply line on a side of the cold water tank, and connected to the water receiving container;
a switch valve provided at a branch point where the return pipe branches off from the raw water supply line, and configured to move between a normal state position in which the switch valve (25) blocks communication between the raw water supply line and the return pipe and a circulation state position in which the switch valve allows communication between the raw water supply line and the return pipe, while blocking communication between the raw water supply line and the cold water tank; and
a heating arrangement for heating drinking water flowing through a circulation path constituted by the water receiving container, the raw water supply line, the switch valve, and the return pipe.

2. The water dispenser according to claim 1, wherein the hot water tank is disposed at an intermediate portion of the return pipe, and wherein the heating arrangement comprises the hot water tank.

3. The water dispenser according to claim 2, wherein the hot water tank is provided with a drain pipe configured such that drinking water remaining in the hot water tank can be discharged through the drain pipe, and a hot water discharge line configured such that drinking water in the hot water tank can be sent out through the hot water discharge line,
wherein the return pipe is constituted by a first return pipe portion configured such that drinking water can flow from the switch valve to the hot water tank through the first return pipe portion, and a second return pipe portion configured such that drinking water can flow from the hot water tank to the water receiving container through the second return pipe portion, and
wherein the first return pipe portion is connected to the drain pipe, and the second return pipe portion is connected to the hot water discharge line.

4. The water dispenser according to claim 1, wherein the heating arrangement comprises a heating device attached to the circulation path.

5. The water dispenser according to claim 4, wherein the heating device is attached to the raw water supply line.
